(19) United States
(12) Patent Application Publication
(10) Pub. No.: US 2017/0325207 A1
(43) Pub. Date: Nov. 9, 2017

(54) Uplink Allocation Echoing

(71) Applicant: QUALCOMM Incorporated, San Diego, CA (US)

(72) Inventors: Guy Wolf, Rosh Haayin (IL); Lior Uziel, Hod Hasharon (IL); Shaul Shamay, Rishon le Zion (IL); Assaf Touboul, Netanya (IL)

(21) Appl. No.: 15/148,525

(22) Filed: May 6, 2016

(51) Int. Cl. H04W 72/04; H04W 72/12; H04W 88/08; H04W 88/02

(52) U.S. Cl. CPC H04W 72/0406; H04W 88/08; H04W 72/1289; H04W 88/02

(57) ABSTRACT

Interference coordination using over the air data is enabled. A UE receives downlink control information including uplink resource allocation. The UE determines whether it is near a cell edge of its serving cell. If so, the UE echoes at least a subset of the allocation information over the air to one or more neighboring base stations. The echo may use a multi-cluster PUSCH approach or a combined PUSCH, PUCCH approach. One or more neighboring base stations receive the echoed allocation data. With the echoed data, the neighboring base stations engage in interference coordination, thereby avoiding delays inherent in non-idea backhaul connections. Other aspects, embodiments, and features are also claimed and described.

### TECHNICAL FIELD

Aspects of the present disclosure relate generally to wireless communication systems, and more particularly, to echoing resource allocation information to neighboring access points over the air.

### Introduction

In wireless communication networks (e.g., long-term evolution (LTE) systems), for example in small cell deployments, inter-cell interference can be a limiting factor. To address inter-cell interference, current approaches provide for inter-cell coordination (e.g., “inter-cell interference coordination” (ICIC) or “enhanced inter-cell interference coordination” (eICIC)). These have the objective of coordinating uplink (UL) allocations for user equipment (UEs) that are on cell edges and that would otherwise impose UL interference on adjacent cells. To accomplish this coordination, current approaches rely upon backhaul communications between access points (e.g., via X2 interfaces).

But this imposes a burden on the backhaul as well as on processing resources that are dedicated to receiving, transmitting, and applying this information on the backhaul links. Further, the backhaul may not be available to vendors to use or may be limited in terms of latency and/or capacity, which may lead to sub-optimal quasi-static coordination. In an exemplary use application, infrastructure may be provided for coordinated multi-points (e.g., UL CoMP) where several access points process the traffic transmitted by a UE in a joint fashion. This introduces capacity enhancements and UL macro diversity benefits, but it relies upon tight coordination among the access points via the backhaul/X2 interfaces that is typically non-ideal.

Another approach to the problem of inter-cell interference involves the use of nonlinear receiver architectures that involve interference cancellation techniques. However, this approach usually includes the receiver having awareness of the interference source transmission parameters which may result in exponentially increasing the processing complexity at the access point (e.g., due to hypothesis testing). Another example approach is to include downlink (DL) sniffing capabilities to the access points, so the access points may listen to the DL allocation broadcasts of its neighboring cells. But this poses several drawbacks, including UL/DL coverage asymmetry (neighboring access point DL message received at weaker signal strength compared to UE at the cell's edge), and the inapplicability to single frequency networks (a sniffing access point could not receive the DL signal from a neighboring cell's access point without degrading its own DL signal strength, referred to as receiver desensitization).

As a result, there is a need for techniques to allow resource allocation information to be signaled to UEs in a manner that reduces the overhead to do so as well as improves the efficiency.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method is provided that includes receiving, at a first wireless communications device, uplink configuration information in a downlink message from a second wireless communications device. The method further includes determining, by the first wireless communications device, whether the first wireless communications device is being served at a cell edge of the second wireless communications device. The method further includes transmitting, by the first wireless communications device in response to determining it is being served at a cell edge, at least a subset of the uplink configuration information in an uplink message to a third wireless communications device.

In an additional aspect of the disclosure, a method is provided that includes receiving, at a first wireless communications device of a first cell, echoed uplink configuration information from a second wireless communications device being served at a cell edge of a second cell of a third wireless communications device. The method further includes processing, upon receipt by the first wireless communications device, the echoed uplink configuration information. The method further includes performing, upon processing by the first wireless communications device, interference coordination between the first wireless communications device and the third wireless communications device based on the echoed uplink configuration information of the second wireless communications device.

In an additional aspect of the disclosure, a first wireless communications device is provided that includes a processor configured to determine whether the first wireless communications device is being served at a cell edge of a second wireless communications device. The first wireless communications device further includes a transceiver configured to receive uplink configuration information in a downlink message from the second wireless communications device, and transmit, in response to the processor determining that the first wireless communications device is being served at a cell edge, at least a subset of the uplink configuration information in an uplink message to a third wireless communications device.

In an additional aspect of the disclosure, a first wireless communications device is provided that includes a transceiver configured to receive, at the first wireless communications device of a first cell, echoed uplink configuration information from a second wireless communications device being served at a cell edge of a second cell of a third wireless communications device. The first wireless communications device further includes a processor configured to process, upon receipt by the first wireless communications device, the echoed uplink configuration information, and perform, upon processing by the first wireless communications device, interference coordination between the first wireless communications device and the third wireless communications device based on the echoed uplink configuration information of the second wireless communications device.

In an additional aspect of the disclosure, a computer readable medium having program code recorded thereon is provided, the program code including code for causing a first wireless communications device to receive uplink configuration information in a downlink message from a second wireless communications device. The program code further includes code for causing the first wireless communications device to determine whether the first wireless communications device is being served at a cell edge of the second wireless communications device. The program code further includes code for causing the first wireless communications device to transmit, in response to determining the first wireless communications device is being served at a cell edge, at least a subset of the uplink configuration information in an uplink message to a third wireless communications device.

In an additional aspect of the disclosure, a computer readable medium having program code recorded thereon is provided, the program code including code for causing a first wireless communications device of a first cell to receive echoed uplink configuration information from a second wireless communications device being served at a cell edge of a second cell of a third wireless communications device. The program code further includes code for causing the first wireless communications device to process, upon receipt by the first wireless communications device, the echoed uplink configuration information. The program code further includes code for causing the first wireless communications device to perform, upon processing by the first wireless communications device, interference coordination between the first wireless communications device and the third wireless communications device based on the echoed uplink configuration information of the second wireless communications device.

In an additional aspect of the disclosure, a first wireless communications device is provided that includes means for receiving uplink configuration information in a downlink message from a second wireless communications device. The first wireless communications device further includes means for determining whether the first wireless communications device is being served at a cell edge of the second wireless communications device. The first wireless communications device further includes means for transmitting, in response to determining the first wireless communications device is being served at a cell edge, at least a subset of the uplink configuration information in an uplink message to a third wireless communications device.

In an additional aspect of the disclosure, a first wireless communications device is provided that includes means for receiving, at the first wireless communications device of a first cell, echoed uplink configuration information from a second wireless communications device being served at a cell edge of a second cell of a third wireless communications device. The first wireless communications device further includes means for processing, upon receipt by the first wireless communications device, the echoed uplink configuration information. The first wireless communications device further includes means for performing, upon processing by the first wireless communications device, interference coordination between the first wireless communications device and the third wireless communications device based on the echoed uplink configuration information of the second wireless communications device.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates an exemplary wireless communication environment according to embodiments of the present disclosure.

FIG. 2 is a block diagram of an exemplary wireless communication device according to embodiments of the present disclosure.

FIG. 3 is a block diagram of an exemplary wireless communication device according to embodiments of the present disclosure.

FIG. 4 is a block diagram illustrating an exemplary transmitter and receiver system, such as a base station and a user equipment, in accordance with various aspects of the present disclosure.

FIG. 5 is a diagram illustrating signaling between wireless communication devices according to embodiments of the present disclosure.

FIG. 6A is a block diagram of an exemplary resource allocation structure according to embodiments of the present disclosure.

FIG. 6B is a block diagram of an exemplary resource allocation structure according to embodiments of the present disclosure.

FIG. 6C is a block diagram of an exemplary resource allocation structure according to embodiments of the present disclosure.

FIG. 7 is a flowchart illustrating an exemplary method for wireless communication in accordance with various aspects of the present disclosure.

FIG. 8 is a flowchart illustrating an exemplary method for wireless communication in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA, LTE networks, GSM networks, and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies, such as a next generation (e.g., 5th Generation (5G)) network.

Further, devices may also communicate with one another using various peer-to-peer technologies such as LTE-Direct (LTE-D), Bluetooth, Bluetooth Low Energy (BLE), ZigBee, radiofrequency identification (RFID), and/or other ad-hoc or mesh network technologies. Embodiments of this disclosure are directed to any type of modulation scheme that may be used on any one or more of the above-recited networks and/or those yet to be developed.

Embodiments of the present disclosure introduce systems and techniques to enable base stations to more efficiently engage in interference coordination based on data echoed over the air from one or more UEs. For example, when a UE receives downlink control information that includes uplink resource allocation, the UE may determine whether it is at or near a cell edge of its serving cell. If it is, the UE may take at least some subset (if not substantially all) of the information included in the downlink control message, including at least uplink resource allocation, and echo that information over the air.

In an embodiment, the UE may echo the uplink allocation data by placing the data into a slice of resource blocks taken from the physical uplink shared channel (PUSCH). The UE may do so using multi-cluster transmission, so that the UE, as it transmits regular data in its allocated resource blocks on the PUSCH in a primary cluster, it may also transmit the uplink allocation data in the resource blocks from the small slice in a secondary cluster. When using this multi-cluster PUSCH approach, a different resource block (or blocks) may be reserved in the slice for each neighboring base station that is expected (or known) to be able to receive the echoed uplink allocation data. In another embodiment, the UE may echo the uplink allocation data by multiplexing the data into resource elements in a physical uplink control channel (PUCCH), thereby leaving the efficiency of the PUSCH untouched.

The echoed uplink allocation data may be received by one or more neighboring base stations (e.g., base stations whose cell coverage neighbors on the cell on whose edge the echoing UE is currently located). Thus, uplink allocation data used in interference coordination that previously was shared via one or more backhaul connections between the base stations themselves is now echoed over the air from the UEs themselves. This reduces the inefficiencies caused by the backhaul connections, thereby improving the quality and/or speed of interference coordination so it may be dynamically implemented.

With the echoed uplink allocation data, the neighboring base station(s) 104 implement one or more interference coordination approaches. For example, a neighboring base station 104 may implement inter-cell interference coordination, enhanced inter-cell interference coordination, coordinated multi-point, and/or interference cancellation (to name just a few examples). Using this approach, uplink transmission link budget is preserved and includes the option to notify any neighboring base stations of UE transmission parameters for use as side information (such as the interference coordination options mentioned above).

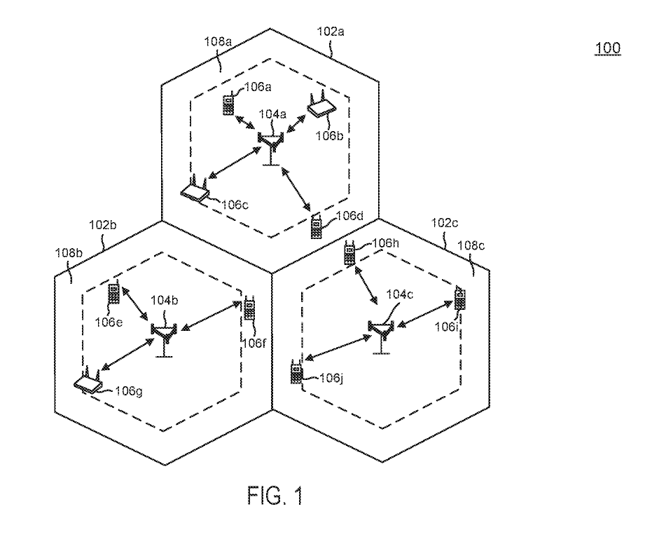

FIG. 1 illustrates a wireless communication network 100 in accordance with various aspects of the present disclosure. The wireless network 100 may include a number of base stations 104 and a number of user equipment (UE) 106, all within one or more cells 102 as illustrated in FIG. 1. The communications environment 100 may support operation on multiple carriers (e.g., waveform signals of different frequencies). Multi-carrier transmitters can transmit modulated signals simultaneously on the multiple carriers. For example, each modulated signal may be a multi-carrier channel modulated according to the various radio technologies described above. Each modulated signal may be sent on a different carrier and may carry control information (e.g., pilot signals, control channels, etc.), overhead information, data, etc. The communications environment 100 may be a multi-carrier LTE network capable of efficiently allocating network resources. The communications environment 100 is one example of a network to which various aspects of the disclosure apply. For example, in some scenarios the environment 100 may be a 5G network or a network comprised of several co-existing convergent networks.

The base stations 104 may include an evolved Node B (eNodeB). A base station 104 may also be referred to as an access point, base transceiver station, a node B, eNB, etc. A base station 104 may be a station that communicates with the UEs 106. A UE 106 may communicate with the base station 104 via an uplink and a downlink. The downlink (or forward link) refers to the communication link from the base station 104 to the UE 106. The uplink (or reverse link) refers to the communication link from the UE 106 to the base station 104. The base stations 104 may also communicate with one another, directly or indirectly, over wired and/or wireless backhaul connections, such as via one or more X2 interfaces (to name one example).

UEs 106 may be dispersed throughout the wireless network 100, as shown (e.g., 106a, 106b, 106c, 106d, 106e, 106f, 106g, 106h, 106i, and 106j), and each UE 106 may be stationary or mobile. The UE 106 may also be referred to as a terminal, a mobile station, a subscriber unit, etc. The UE 106 may be a cellular phone, a smartphone, a personal digital assistant, a wireless modem, a laptop computer, a tablet computer, a drone, an entertainment device, a hub, a gateway, an appliance, a wearable, peer-to-peer and device-to-device components/devices (including fixed, stationary, and mobile), Internet of Things (IoT) components/devices, and Internet of Everything (IoE) components/devices, etc. Some of the UEs 106 may be relay stations, which receive transmission of data and/or other information from an upstream station (e.g., a base station, a UE, or the like) and sends a transmission of the data and/or other information to a downstream station (e.g., another UE, another base station, or the like). The wireless communication network 100 is one example of a network to which various aspects of the disclosure apply.

Each base station 104 may provide communication coverage for a particular geographic area. This is illustrated as cell 102a for base station 104a, cell 102b for base station 104b, and cell 102c for base station 104c. In 3GPP, the term “cell” can refer to this particular geographic coverage area of a base station and/or a base station subsystem serving the coverage area, depending on the context in which the term is used. In this regard, the cells 102 may be macro cells, pico cells, femto cells, and/or other types of cells (and/or some combination of the above).

A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a pico cell may be referred to as a pico base station. And, a base station for a femto cell may be referred to as a femto base station or a home base station. A base station 104 may support one or multiple (e.g., two, three, four, and the like) cells.

In some implementations, the wireless network 100 utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

As UEs 106 traverse regions further away from the base station 104 serving it, they may periodically traverse cell edge regions that are at the edge of the base station 104's coverage. Such cell edges represent a location that is still within coverage for a given base station 104, but which is near a region where coverage becomes better from a different base station. This is illustrated as regions 108 in FIG. 1. For example, region 108a corresponds to a cell edge region for cell 102a, region 108b corresponds to a cell edge region for cell 102b, and region 108c corresponds to a cell edge region for cell 102c. At these cell edge regions 108, UEs 106 typically use noticeably higher power on the UL than is used closer to the serving base station 104.

According to embodiments of the present disclosure, UEs 106 that are in regions 108 may echo their UL allocation data over the air, which may be received by neighboring base stations 104 and used for interference coordination at the neighboring base station 104, thereby providing coordination in a manner that is not limited by any potential bandwidth and/or timing constraints imposed by backhaul connections between the base stations 104 themselves.

For example, in the illustrated environment 100, UE 106d is in a cell edge region 108a of cell 102a. In neighboring cell 102c, UE 106h is similarly in a cell edge region 108c of cell 102c, along a boundary neighboring the cell 102a. Thus, there is the possibility of interference due to lack of coordination between base stations 104a and 104c, or too much delay in their coordination, for the allocation of UL resources in each cell 102. As another example, UE 106f is in a cell edge region 108b or cell 102b, along a boundary neighboring the cell 102c. In neighboring cell 102c, the UE 106j is in a cell edge region 108c of cell 102c that is along the boundary neighboring the cell 102b. As another example, UEs 106c and 106g are in cell edge regions 108a and 108b, respectively.

The present disclosure will use UEs 106d and 106h for ease of illustration and discussion. When the UE 106d receives downlink control information (DCI) from its serving base station 104a, according to embodiments of the present disclosure the UE 106d may determine whether it is in a cell edge region 108 and/or whether the transmit power allocated for UL is above a threshold (which may correspond to an increased likelihood of interference with UL allocation in the neighboring cell 102c, where frequency reuse is 1 for example). If it is not, then the UE 106d may continue operations (for example, UE 106a may determine that it is not in a cell edge region 108a). If, as is illustrated in FIG. 1, the UE 106d determines that it is in the cell edge region 108a, then it may echo at least some subset of its DCI in a broadcast. For example, the echo transmission may include UL resource allocation (e.g., by using similar encoding as is used in DCI0 resource allocation), modulation and coding scheme (MCS) information, demodulation reference signal (DMRS) information, and radio network temporary identifier (RNTI) (reduced or full, for example).

Base station 104c in cell 102c neighboring the cell 102a may be in sufficient proximity to detect the echoed transmission from UE 106d, while base station 104b in neighboring cell 102b may not detect the echoed transmission from the UE 106d (while in other embodiments, it may as well). With the echoed DCI information, the base station 104c may perform some form of interference coordination (e.g., ICIC, eICIC, CoMP, and/or interference cancellation to name some examples). By echoing this information over the air from the UEs 106 themselves, instead of relying on inter-base station coordination via backhaul connections (e.g., X2), the base stations 104 may more quickly, efficiently, and thereby dynamically engage in interference coordination to address interference and/or increase throughput for UEs 106 at edges of cells 102.

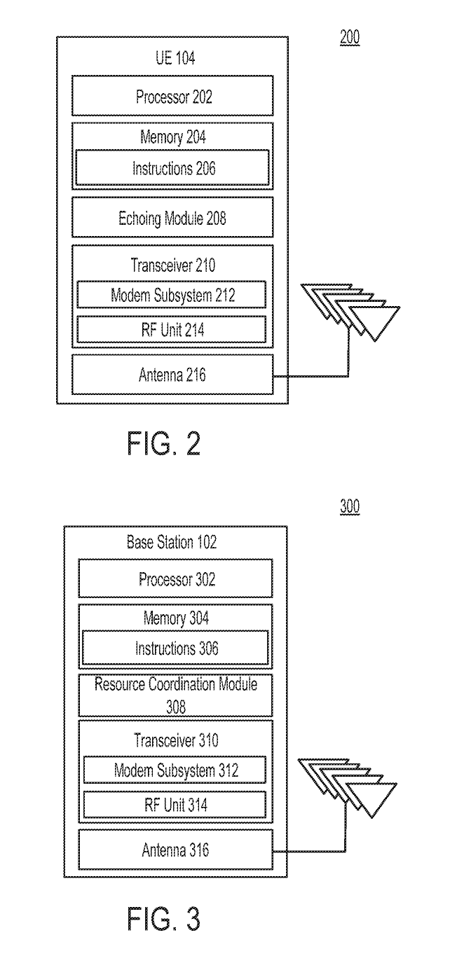

FIG. 2 is a block diagram of an exemplary wireless communication device 200 according to embodiments of the present disclosure. The wireless communication device 200 may be a UE having any one of many configurations described above. For purposes of example, wireless communication device 200 may be a UE 106 as discussed above with respect to FIG. 1. The UE 106 may include a processor 202, a memory 204, an echoing module 208, a transceiver 210 (including a modem 212 and RF unit 214), and an antenna 216. These elements may be in direct or indirect communication with each other, for example via one or more buses.

The processor 202 may have various features as a specific-type processor. For example, these may include a central processing unit (CPU), a digital signal processor (DSP), an application-specific integrated circuit (ASIC), a controller, a field programmable gate array (FPGA) device, another hardware device, a firmware device, or any combination thereof configured to perform the operations described herein with reference to the UEs 106 introduced in FIG. 1 above. The processor 202 may also be implemented as a combination of computing devices, e.g., a combination of a DSP and a microprocessor, a plurality of microprocessors, one or more microprocessors in conjunction with a DSP core, or any other such configuration.

The memory 204 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some embodiments, the memory 204 may include a non-transitory computer-readable medium. The memory 204 may store instructions 206. The instructions 206 may include instructions that, when executed by the processor 202, cause the processor 202 to perform operations described herein with reference to a UE 106 in connection with embodiments of the present disclosure. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The echoing module 208 may be used for various aspects of the present disclosure. The echoing module 208 may include various hardware components and/or software components to assist in determining whether the UE 106 should echo some or all of its UL allocation data (also referred to herein as UL allocation information or UL configuration data). For example, the echoing module 208, upon receipt of DCI from its serving base station 104 (e.g., each time DCI is received or every x^{th} time of receipt), may analyze location and/or allocated transmit power for the UL to determine whether the UE 106 is close enough to a cell edge region 108 so as to warrant echoing UL allocation data.

The echoing module 208, upon determining that echoing UL allocation data is warranted, initiates the echoing. As part of this, the echoing module 208 may determine what particular data, such as UL parameters, to include in the echo transmission. The particular parameters to include may be at least partially dependent on the type of system implemented at the serving base station 104. For example, if the base station 104 has implemented a more complex transceiver (at least on the receiver side), then the echoing module 208 (being previously informed of this) may determine to echo less of the UL allocation parameters. If, however, a less complex receiver is implemented on the base station 104 side, then the echoing module 208 (being previously informed of this) may determine to echo more and/or most (if not all) of the UL allocation parameters included in the DCI.

Some examples of particular parameters include UL resource allocation, such as using similar encoding as in DCI0 (which may take up to 13 bits for a 20 MHz carrier, for example). Another example is modulation (such as MCS), which may take 2 bits in an example. Another example may be DMRS, which may take 3 bits in an example. Another example is RNTI. For example, the echoing module 208 may have a reduced RNTI (e.g., being given to the UE 106 as a cell edge user) that may have a length 3 (e.g., allowing 8 UEs 106 per square foot per cell). Other parameters may additionally or alternatively be included.

According to embodiments of the present disclosure, there are various ways in which the UL allocation data may be echoed to neighboring base stations 104. In an embodiment, the UE 106 may utilize a small fraction of resource blocks from the PUSCH. In another embodiment, the UE 106 may utilize multiplexing capabilities of the PUCCH. In either alternative, the UE 106 may echo the UL allocation data concurrent to transmitting “regular” UL data to the serving base station 104 (e.g., simultaneously transmitting the UL allocation data as an echo and the regular data, such as using cluster transmission). The echoing module 208 may, in an embodiment, determine which to approach to use (echoing in a portion of the PUSCH or in the PUCCH). In another embodiment, the echoing module 208 may implement the approach already specified by a base station 104 or pre-stored by the operator of one or more elements of the wireless network 100.

However decided, the echoing module 208 may coordinate with the transceiver 210 to place the UL allocation data in the appropriate resources in the appropriate channel (whether a partitioned region of PUSCH or in PUCCH) and instruct the transceiver to proceed with transmission. Upon transmission, the echoed UL allocation data is available to any neighboring base station 104 that is able to receive the signal, and thereby used for interference coordination. This allows for the neighboring base stations 104 to have a fast, dynamic (since it is transmitted repeatedly over time) understanding of potential interference from a UE 106 at a cell edge of a neighboring cell that is not possible using non-ideal backhaul connections.

As shown, the transceiver 210 may include the modem subsystem 212 and the radio frequency (RF) unit 214. The transceiver 210 can be configured to communicate bi-directionally with other devices, such as base stations 104 and/or other network elements. The modem subsystem 212 may be configured to modulate and/or encode data according to a MCS, e.g., a LDPC coding scheme, a turbo coding scheme, a convolutional coding scheme, a polar coding scheme, etc. The RF unit 214 may be configured to process (e.g., perform analog to digital conversion or digital to analog conversion, etc.) modulated/encoded data from the modem subsystem 212 (on outbound transmissions) or of transmissions originating from another source such as a base station 104. Although shown as integrated together in transceiver 210, the modem subsystem 212 and the RF unit 214 may be separate devices that are coupled together at the UE 106 to enable the UE 106 to communicate with other devices.

The RF unit 214 may provide the modulated and/or processed data, e.g. data packets (or, more generally, data messages that may contain one or more data packets and other information) such as UL data and echoed UL allocation data of the present disclosure, to the antenna 216 for transmission to one or more other devices. This may include, for example, transmission of the UL allocation data in a control channel, such as PUCCH, or in a partitioned portion of PUSCH, as part of a cluster transmission with regular data in a portion of PUSCH according to embodiments of the present disclosure. The antenna 216 may further receive data messages transmitted from other devices and provide the received data messages for processing and/or demodulation at the transceiver 210. As illustrated, antenna 216 may include multiple antennas of similar or different designs in order to sustain multiple transmission links.

FIG. 3 is a block diagram of an exemplary wireless communication device 300 according to embodiments of the present disclosure. The wireless communication device 300 may be a base station having any one of many configurations described above. For purposes of example, wireless communication device 300 may be a base station 104 as discussed above with respect to FIG. 1. The base station 104 may include a processor 302, a memory 304, a resource coordination module 308, a transceiver 310 (including a modem 312 and RF unit 314), and an antenna 316. These elements may be in direct or indirect communication with each other, for example via one or more buses.

The processor 302 may have various features as a specific-type processor. For example, these may include a CPU, a DSP, an ASIC, a controller, an FPGA device, another hardware device, a firmware device, or any combination thereof configured to perform the operations described herein with reference to the base stations 104 introduced in FIG. 1 above. The processor 302 may also be implemented as a combination of computing devices, e.g., a combination of a DSP and a microprocessor, a plurality of microprocessors, one or more microprocessors in conjunction with a DSP core, or any other such configuration.

The memory 304 may include a cache memory (e.g., a cache memory of the processor 302), RAM, MRAM, ROM, PROM, EPROM, EEPROM, flash memory, solid state memory device, hard disk drives, other forms of volatile and non-volatile memory, or a combination of different types of memory. In some embodiments, the memory 304 may include a non-transitory computer-readable medium. The memory 304 may store instructions 306. The instructions 306 may include instructions that, when executed by the processor 302, cause the processor 302 to perform operations described herein with reference to a base station 104 in connection with embodiments of the present disclosure.

The resource coordination module 308 may be used for various aspects of the present disclosure. The resource coordination module 308 may include various hardware components and/or software components to assist in performing interference coordination (whether ICIC, eICIC, CoMP, cancellation, etc.) upon receiving and decoding UL allocation data. For example, the resource coordination module 308, upon receipt of echoed UL allocation data from a UE 106 at a cell edge region 108 of a neighboring cell 102, may decode the echoed UL allocation data. This provides the information used for interference coordination that was previously conveyed between the base stations 104 themselves via one or more backhaul connections, resulting in non-ideal situations.

For example, the resource coordination module 308, with the decoded data, may determine (with the processor 302 and/or its own dedicated processor) whether a different frequency allocation for one or more UEs 106 being served in its own cell should be adjusted according to ICIC. As another example, the resource coordination module 308 may determine whether a different time allocation for one or more UEs 106 being served in its own cell should be adjusted according to eICIC. As another example, the resource coordination module 308 may determine time, frequency, and/or spatial domain allocation to perform CoMP to increase the throughput for the UE 106 that echoed its UL allocation data (or, in other words, that is in a cell edge region 108 that may benefit from CoMP). The type of CoMP performed may be for DL (e.g., joint processing, coordinated scheduling, coordinated beamforming) or UL (e.g., reception or joint detection) communication with the cell edge UE 106 (e.g., UEs 106d or 106h in the example of FIG. 1). In embodiments where CoMP may be implemented, the UL allocation data echoed may also include information such as one or more channel quality indicators, precoding data, and/or data stream indicators.

In embodiments where interference cancellation is implemented, the UL allocation data may be used to cancel out any regular UL data (e.g., sent via PUSCH to the serving base station 104) from the UE 106 in a neighboring cell 102. Thus, if the base station is receiving the echoed UL allocation data from a UE 106 in a neighboring cell 102, which by extension suggests that the base station 104 is also receiving the data on PUSCH for the serving base station 104, the neighboring base station 104 may ignore the data on PUSCH where it is using some same resource as is used in the neighboring cell 102 for a UE 106.

As shown, the transceiver 310 may include the modem subsystem 312 and the RF unit 314. The transceiver 210 can be configured to communicate bi-directionally with other devices, such as UEs 106 and/or other network elements. The modem subsystem 312 may be configured to modulate and/or encode data according to a MCS, e.g., a LDPC coding scheme, a turbo coding scheme, a convolutional coding scheme, a polar coding scheme, etc. The RF unit 314 may be configured to process (e.g., perform analog to digital conversion or digital to analog conversion, etc.) modulated/encoded data from the modem subsystem 312 (on outbound transmissions) or of transmissions originating from another source such as a UE 106.

Although shown as integrated together in transceiver 310, the modem subsystem 312 and the RF unit 314 may be separate devices that are coupled together at the base station 104 to enable the base station 104 to communicate with other devices. An example of at least a portion of a transceiver that may be used according to embodiments of the present disclosure is a successive interference cancellation (SIC) receiver. Another example, may be an interference rejection combining (IRC) receiver. These are just two examples; embodiments of the present disclosure are not limited to these types of receivers that are provided for sake of illustration.

The RF unit 314 may provide the modulated and/or processed data, e.g. data packets (or, more generally, data messages that may contain one or more data packets and other information) such as DCI and regular data (DL) of the present disclosure, to the antenna 316 for transmission to one or more other devices. The antenna 316 may further receive data transmitted from other devices and provide the received data messages for processing and/or demodulation at the transceiver 310. This may include, for example, receiving the UL allocation data in a control channel, such as PUCCH, or in a partitioned portion of PUSCH, as part of a cluster transmission with regular data in a portion of PUSCH according to embodiments of the present disclosure. As illustrated, antenna 316 may include multiple antennas of similar or different designs in order to sustain multiple transmission links.

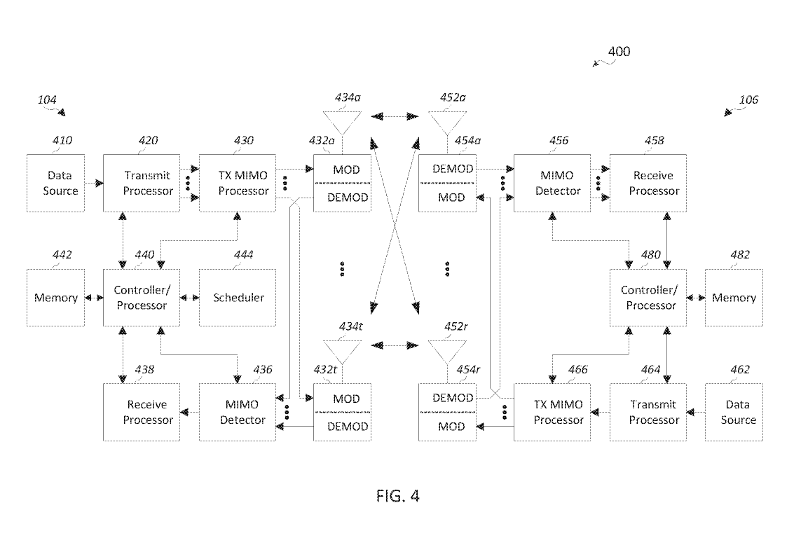

FIG. 4 shows a block diagram illustrating communication between two wireless communication devices of a MIMO system 400 in accordance with the present disclosure. For sake of clarity in explanation, a base station 104 and a UE 106 are shown. However, it is understood that the following description is applicable to communication between any two wireless communication devices in accordance with the present disclosure. Further, the following discussion will focus on those aspects pertinent to the present disclosure; as will be recognized, the elements of FIG. 4 may be further used for other purposes.

At the base station 104, a transmit processor 420 may receive data from a data source 410 and control information from a controller/processor 440. The data rate, coding, and modulation for each data stream may be determined by instructions performed by processor 430. The transmit processor 420 may process (e.g., encode and symbol map) the data and control information to obtain data symbols and control symbols, respectively. This may include, for example, symbol mapping based on a particular modulation scheme (e.g., BPSK, QSPK, M-PSK, or M-QAM). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t.

Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via antennas 434a through 434t, respectively. As some examples, the antennas 434a through 434t may transmit DCI and regular data where the base station 104 is the one serving the UE 106 that is the targeted recipient. Embodiments of the present disclosure include having only one antenna or having multiple antennas (at one or both of base station 104 and UE 106).

At the UE 106, antennas 452a through 452r may receive the downlink signals from the base station 104 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for 01-DM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 106 (e.g., DCI and regular data as just two examples pertinent to embodiments of the present disclosure), and provide decoded control information to a controller/processor 480.

On the uplink, at the UE 106, a transmit processor 464 may receive and process data from a data source 462 (e.g., echoing module 208 of FIG. 2) and control information from the controller/processor 480. The data may include UL allocation data according to embodiments of the present disclosure directed to (e.g., broadcast) one or more neighboring base stations 104, a request for updated system information, regular UL data directed to the serving base station 104, and/or connection setup or response information. The transmit processor 464 may also generate reference symbols for a reference signal.

The symbols from the transmit processor 464 may be precoded by a TX MIMO processor 466 if applicable, further processed by the modulators 454a through 454r (e.g., for SC-FDM, etc.), and transmitted to the base station 104. At the base station 104, the uplink signals from the UE 106 may be received by the antennas 434, processed by the demodulators 432, detected by a MIMO detector 436, if applicable, and further processed by a receive processor 438 to obtain decoded data and control information sent by the UE 106 (e.g., where it is a neighboring base station 104, the echoed UL allocation data). The processor 438 may provide the decoded data to a data sink and the decoded control information to the controller/processor 440.

The controllers/processors 440 and 480 may direct the operation at the base station 104 and the UE 106, respectively. The controller/processor 440 and/or other processors and modules at the base station 104 may perform or direct the execution of various processes for the techniques described herein, including transmitting DCI as a serving base station 104 and utilizing decoded echoed UL allocation data at a neighboring base station 104 in interference coordination. The controllers/processor 480 and/or other processors and modules at the UE 106 may also perform or direct the execution of the various processes for the techniques described herein, including determining whether the UE 106 is at the edge of its serving cell 102, determining what UL allocation data to echo, and echoing the UL allocation data.

In this regard, the memories 442 and 482 may store data and program codes for the base station 104 and the UE 106, respectively, to perform or direct the execution of these various processes. A scheduler 444 may schedule wireless communication devices for data transmission on the downlink and/or uplink.

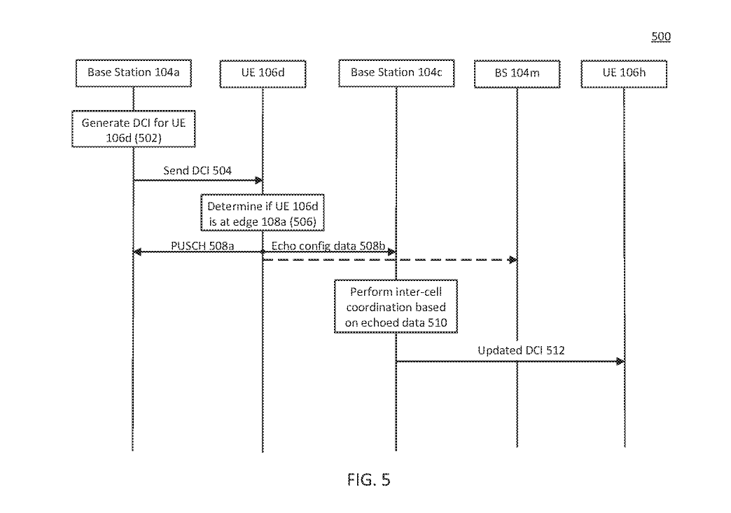

The interactions described with respect to FIGS. 1-5 above are illustrated in FIG. 5, which provides a diagram 500 illustrating signaling between wireless communication devices, such as base stations 104 and UEs 106, according to embodiments of the present disclosure. For simplicity of discussion, the particular example using base stations 104a, 104c, and UEs 106d and 106h, will be used.

At action 502 (a given point in time), the base station 104a, which serves the UE 106d, generates DCI for the UE 106d (e.g., according to any of the DCI formats such as DCI0).

At action 504, the base station 104a sends the DCI generated at action 502 to the UE 106d. The DCI will include information including UL allocation that the UE 106d will use for a subsequent transmit period.

At action 506, the UE 106d, having received the DCI sent at action 504, determines whether the UE 106d is at a cell edge of its serving cell, whether based on a physical location of the UE 106d as compared to the geographic coverage of the cell 102a, a transmit power allocated in the DCI being above a threshold, or some combination of the above and other factors. In this example, the UE 106d determines that it is at the cell edge region 108a as illustrated in FIG. 1.

At action 508, the UE 106d performs two actions: it sends regular data via PUSCH to its serving base station 104a at action 508a and echoes the UL allocation data at action 508b. These may occur concurrently or almost concurrently (e.g., near each other in time). In an embodiment, the UE 106d utilizes multi-cluster UL transmission. Thus, the UE 106d may use two different regions, identified as two different clusters, to transmit the two groups of data concurrently (e.g., simultaneously) or almost concurrently).

As illustrated in FIG. 5, the echoing of the UL allocation data of action 508b may be echoed (e.g., broadcast) to multiple base stations 104, in this example base station 104c with base station 104m representing one or more other neighboring base stations 104.

At action 510, a neighboring base station 104c that receives the echoed UL allocation data may dynamically decode the data (e.g., right upon receipt) and perform inter-cell coordination. Examples of inter-cell coordination, as mentioned above, may include ICIC, eICIC, CoMP, and/or interference cancellation.

Where the interference coordination at action 510 includes some type of modification to one or more resource allocations (whether frequency, time, or both) for one or more UEs 106 in cell 102c for base station 104c (here, for example, where UE 106h was allocated the same frequency resources as identified in the UL allocation data), the base station 104c may send the updated allocation information at action 512 via one or more DCI messages.

As can be seen in this particular example, while describing base station 104c as the neighbor from the perspective of base station 104a and UE 106d, base station 104a is similarly a neighbor from the perspective of base station 104c and UE 106h and may follow the same signaling procedure discussed above (and, likewise, for any number of base stations 104 and UEs 106). In this example, where UEs 106d and 106h are near each other in neighboring cells, the issue of commonly allocated resources may occur on a first-in-time basis, where the first UE 106 to echo its UL allocation data may trigger the neighboring base station 104 to modify its own UL allocations, and vice versa. In another embodiment, different base stations 104 may be assigned different priority levels, and a given base station 104 that is aware of these priority levels (and where it is located within an environment 100) may respond accordingly, such that a lower priority base station 104 may modify its own allocations as opposed to a neighboring base station 104 with higher priority.

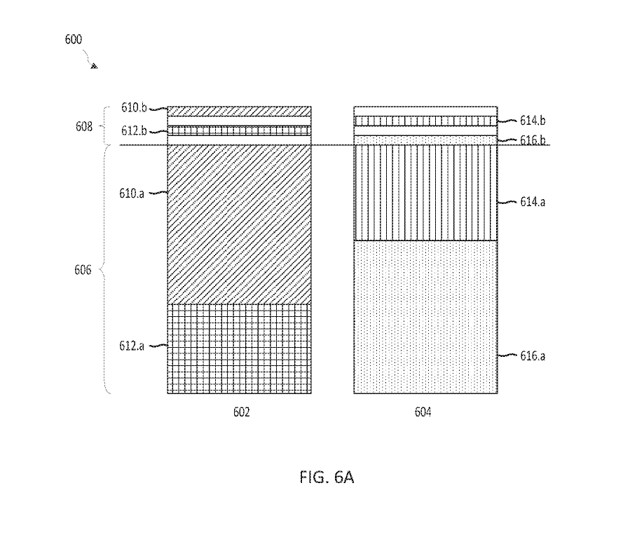

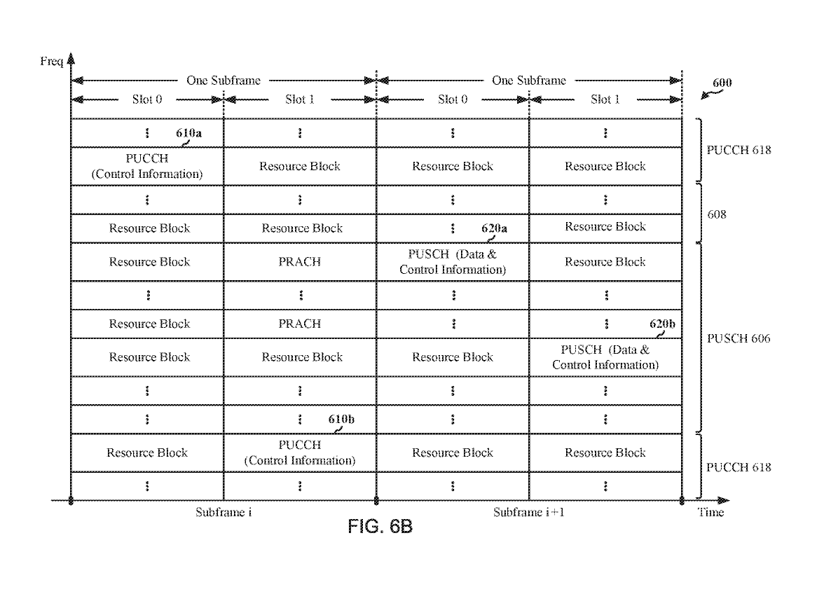

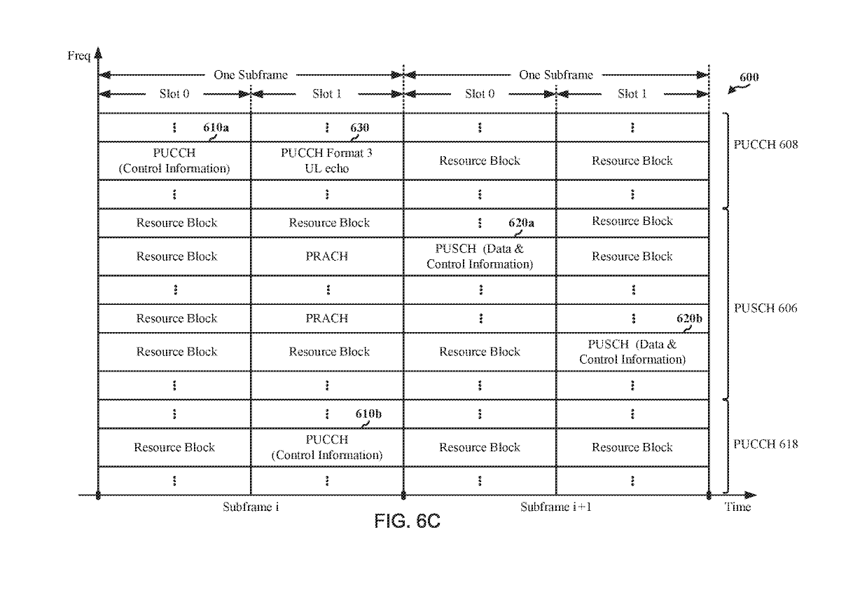

As mentioned above, the UEs 106 may echo their UL allocation data using multi-cluster UL transmission. An exemplary division of clusters is illustrated in FIG. 6A. In particular, FIG. 6A is a block diagram of an exemplary resource allocation UL frame structure 600 according to embodiments of the present disclosure. In particular, FIG. 6A illustrates two respective UL frame structures 602 and 604. UL frame structure 602 may correspond to a first base station 104, such as 104a from the above example. UL frame structure 604 may correspond to a second base station 104, such as 104c from the above example, and the two base stations may be neighboring each other.

As illustrated, each UL frame structure 602, 604 includes a data transmission region 606 and an UL allocation echo transmission region 608. The data transmission region 606 corresponds to a PUSCH for each respective base station 104. In an embodiment, the UL allocation echo transmission region 608 represents a small portion (also referred to as a slice) of the PUSCH. This may be a small percentage (e.g., 10%, or less or more as just an example) of the PUSCH region so as to minimize the reduction to efficiency in the UL. In an alternative embodiment, the UL allocation echo transmission region 608 represents utilization of the PUCCH (e.g., according to format 3), such that the data transmission region 606 represents a full PUSCH frequency range that avoids the efficiency reduction from the other embodiment.

For example, the UL frame structure 602 for base station 104a as illustrated has two data PUSCH clusters 610.a and 612.a. Further, the UL frame structure 602 as illustrated has two echoing clusters (whether in a PUSCH slice or multiplexed into PUCCH) 610.b and 612.b, respectively (this is for simplicity of discussion; the PUSCH may be allocated in any number of clusters). In the illustrated embodiment, the cluster 610.a represents a first cluster for UE 106d, also referred to as a primary cluster, and the cluster 610.b represents a second cluster for the UE 106d, also referred to as a secondary cluster. The UE 106d transmits its regular UL data via the primary cluster 610.a and echoes the UL allocation data via the secondary cluster 610.b, thereby transmitting both concurrently according to multi-cluster UL transmission principles. The use of cluster 612.a as a primary cluster for UL data for a different UE 106 (such as 106c for this example), and the cluster 612.b as a secondary cluster for echoing UL allocation data for the UE 106c, is also illustrated. Echoed data may be received by the neighboring base station 104c.

As another example, the UL frame structure 604 for base station 104c as illustrated has two data PUSCH clusters 614.a and 616.a. Further, the UL frame structure 604 as illustrated has two echoing clusters (whether in a PUSCH slice or multiplexed into PUCCH) 614.b and 616.b, respectively. In the illustrated embodiment, the cluster 614.a represents a primary cluster for UE 106h in the UL frame structure 604, and the cluster 614.b represents a secondary cluster for the UE 106h. The UE 106h transmits its regular UL data via the primary cluster 614.a and echoes the UL allocation data via the secondary cluster 614.b, thereby transmitting both concurrently according to multi-cluster UL transmission principles. The use of cluster 616.a as a primary cluster for UL data for a different UE 106 (such as UE 106j for this example), and the cluster 616.b as a secondary cluster for echoing UL allocation data for the UE 106j, is also illustrated.

With this resource structure, efficiency of the UL resources may be optimized while also, at the same time, reducing or removing reliance on the backhaul connections between base stations 104 for interference coordination purposes. Removing this reliance addresses the non-ideal conditions that can be imposed by relying on backhaul connections as opposed to over-the-air communication from the UEs 106 themselves as according to embodiments of the present disclosure.

FIG. 6B is a block diagram of an exemplary resource allocation UL frame structure 600 that presents one of the UL frame structures 602, 604 of FIG. 6A in more detail according to embodiments of the present disclosure. In particular, FIG. 6B illustrates an embodiment where the UE 106 echoes its UL allocation data using multi-cluster PUSCH (i.e., using a slice of the PUSCH for the echoing).

A frame in the UL may have a duration t (e.g., 10 ms) and may be divided into some number of equally sized subframes (e.g., 10). Each subframe may include consecutive time slots, such as two. A resource grid may be used to represent two time slots, each time slot including a resource block (RB), of which multiple are illustrated in FIG. 6B. Each resource block may be divided into multiple resource elements. For a cyclic prefix (e.g., according to LTE), a resource block may contain 12 consecutive subcarriers in the frequency domain and 7 consecutive OFDM symbols in the time domain, for a total of 84 resource elements. For an extended cyclic prefix, an RB may contain 12 consecutive subcarriers in the frequency domain and 6 consecutive OFDM symbols in the time domain, for a total of 72 resource elements. Some of the resource elements may include reference signals (also referred to as pilot signals). The number of bits carried by each resource element depends on the modulation scheme. Thus, the more resource blocks that a UE 106 receives and the higher the modulation scheme, the higher the data rate for the UE 106.

The available resource blocks for the UL may be partitioned into a data section and a control section, illustrated as PUCCH 618 (the control section) and PUSCH 606 (the data section). The PUCCH 610 may be formed at the two edges of the system bandwidth and may have a configurable size. The resource blocks in the PUCCH 618 may be assigned to UEs for transmission of control information. The PUSCH 606 may include all resource blocks not included in the PUCCH 618 and the UL allocation echo transmission region 608. The UL frame structure results in the data section including contiguous subcarriers, which may allow a single UE to be assigned all of the contiguous subcarriers in the data section. In alternative embodiments, a single UE may be assigned to non-contiguous subcarriers (also referred to as component carriers), e.g. according to carrier aggregation principles.

In the illustrated example, several resource blocks in a subframe may be reserved for use as the PUCCH 618. For example, as illustrated, a UE 106 may be assigned resource blocks 410a, 410b in the PUCCH 618 to transmit control information to a base station 104. The UE 106 may also be assigned resource blocks 420a, 420b in the PUSCH 606 to transmit regular data to the base station 104. The UE 106 may transmit regular data or both regular data and control information in the assigned resource blocks in the PUSCH 606. A UL transmission may span both slots of a subframe and may hop across frequency. Further, several resource blocks in a subframe may be reserved for use as the UL allocation echo transmission region 608. In the illustrated embodiment of FIG. 6B, UL allocation echo transmission region 608 (introduced in FIG. 6A) is a slice of resource blocks from the data transmission region 606 (FIG. 6A), identified here specifically as the PUSCH 606.

The UL allocation echo transmission region 608 may be obtained in FIG. 6B by partitioning the total PUSCH (including PUSCH 606 and region 608) into the two distinct regions illustrated. In the region illustrated as PUSCH 606, UL data transmissions may be scheduled. PUSCH 606 in FIG. 6B may have no resource partitioning limitations and may carry a frequency reuse of 1 among cooperating base stations 104 (e.g., neighboring base stations). Other frequency reuse factors may alternatively be used.

In the region illustrated as UL allocation echo transmission region 608, the number of resource blocks may be limited to a minimal amount so as to minimize the impact on UL PUSCH efficiency. The UL allocation echo transmission region 608 serves as the secondary cluster by a UE 106 to echo its UL allocation data used in the first region (here, in PUSCH 606).

In an embodiment, the allocation of the UL allocation echo transmission region 608 between one or more participating UEs 106 may be accomplished by implicitly partitioning the resource blocks among cooperating base stations 104. In embodiments, specific resource blocks in the region 608 may be allocated for the echo UL allocation transmission according to cell 102; therefore, one resource block may be allocated from the region 608 for the cell 102 of each base station 104 participating in embodiments of the present disclosure. Further, these resource blocks in the region 608 may be protected (e.g., a reuse factor greater than 1, such as 3).

For example, it may be obtained based on a logical RNTI order of the cooperating base stations 104. This implicit partitioning is implicitly known to the UEs 106 that determine that they are going to echo their UL allocation data, being derived from their logical RNTIs. In some embodiments, the RNTI used with respect to FIG. 6B may not be a reduced RNTI, while in other embodiments it may be a reduced RNTI.

FIG. 6C is a block diagram of an exemplary resource allocation UL frame structure 600 that presents one of the UL frame structures 602, 604 of FIG. 6A in more detail according to alternative embodiments of the present disclosure. In particular, FIG. 6C illustrates an embodiment where the UE 106 echoes its UL allocation data using PUSCH together with PUCCH (i.e., PUCCH format 3). The differences from FIG. 6B will be addressed.

In the illustrated example, instead of taking a slice of resource blocks from the PUSCH 606, embodiments according to FIG. 6C utilize the PUCCH (control section) for the UL allocation echo transmission region 608, referred to for this example as PUCCH 608.

In contrast to the embodiments of FIG. 6B, resource blocks from PUSCH 606 are not reserved/partitioned for use in echoing UL allocation data. Thus, efficiency of the PUSCH 606 is preserved. In the region illustrated as PUSCH 606, UL data transmissions may be scheduled. PUSCH 606 in FIG. 6C may have no resource partitioning limitations and may carry a frequency reuse of 1 among cooperating base stations 104 (e.g., neighboring base stations). Other frequency reuse factors may alternatively be used.

The PUCCH 608 may be used to convey echoed UL allocation data, for example, by utilizing PUCCH format 3 for the UL resources. Thus, each format 3 resource block in the PUCCH 608 (illustrated by exemplary PUCCH format 3 block 630 in FIG. 6C) may be capable of carrying up to 22 bits for a payload (or other number, depending upon implementation and not excluding future developments with this or other format type) and multiplexing multiple UEs 106 (e.g., 5) per resource block.

The PUCCH 608 serves as the secondary cluster by a UE 106 to echo its UL allocation data used in the first region (here, in PUSCH 606). In an embodiment, the allocation of the PUCCH 608 between one or more participating UEs 106 may be accomplished by implicitly partitioning the PUCCH format 3 resources among cooperating base stations 104 (not all resources in the PUCCH need be used for UL allocation echoing). For example, like in FIG. 6B, partitioning may be obtained based on a logical RNTI order of the cooperating base stations 104. This implicit partitioning is implicitly known to the UEs 106 that determine that they are going to echo their UL allocation data, being derived from their logical RNTIs. In some embodiments, the RNTI used with respect to FIG. 6B may be a reduced RNTI, while in other embodiments it may not be a reduced RNTI.

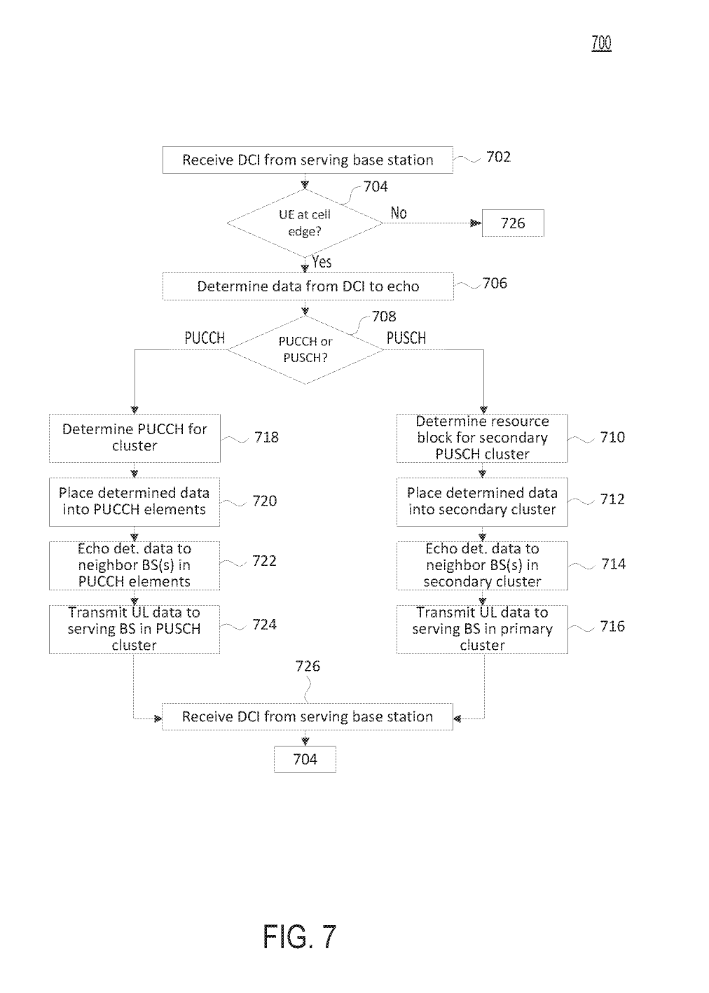

Turning now to FIG. 7, a flowchart is illustrated of an exemplary method 700 for wireless communication in accordance with various aspects of the present disclosure. In particular, the method 700 echoing of UL allocation data according to embodiments of the present disclosure. Method 700 may be implemented by a UE 106 (any number of UEs 106). It is understood that additional steps can be provided before, during, and after the steps of method 700, and that some of the steps described can be replaced or eliminated from the method 700.

At block 702, the UE 106 receives a DCI message from its serving base station 104. Reference is made to a single instance of DCI; DCI may be sent according to a periodicity, and therefore embodiments of the present disclosure may repeat each time a DCI is sent and/or x number of times when DCI is sent.

At block decision 704, the UE 106 determines whether it is located at a cell edge of the cell 102 base station 104 serving the UE 106. For example, the UE 106 may make the determination based on a physical location of the UE 106 as compared to the geographic coverage of the cell 102 of the serving base station 104, a transmit power allocated in the DCI being above a threshold, or some combination of the above and other factors.

If the UE 106 determines that it is not at a cell edge, then the method 700 proceeds to block 726 as discussed below.

If the UE 106 instead determines that it is at a cell edge, then the method 700 proceeds to block 706.

At block 706, the UE 106 determines what subset of data to include from the DCI received at block 702 to include in an echo UL transmission. Some examples of data that may be included are UL resource allocation (e.g., by using similar encoding as is used in DCI0 resource allocation), MCS information, DMRS information, and RNTI (reduced or full, for example), as well as CSI in some embodiments.

At decision block 708, if the UE 106 is configured to echo UL allocation data using multi-cluster PUSCH (e.g., according to FIGS. 6A and 6B), then the method 700 proceeds to block 710.

At block 710, the UE 106 determines what resource blocks to place the UL allocation data determined from block 706. For example, the determination may be based on what base stations 104 have cells 102 that neighbor the current cell(s) serving the UE 106.

At block 712, the UE 106 places the subset of UL allocation data determined from block 706 into the resource block(s) determined from block 710, for example using a similar encoding as is used for DCI0 (to name just one example).

At block 714, the UE 106 echoes the UL allocation data from block 712 to the neighboring base stations 104 using the partitioned PUSCH regions (e.g., region 608).

At block 716, the UE 106 transmits regular data using its allocated resource block(s) in the general PUSCH region to the serving base station 104. Although described as two separate blocks (712/714), in embodiments of the present disclosure the echoed UL allocation data is transmitted in the secondary cluster (region 608 of FIG. 6A) at the same, or near the same, time as the regular UL data.

Returning again to decision block 708, if the UE 106 is configured to echo UL allocation data using PUSCH+PUCCH (e.g., format 3), then the method 700 proceeds to block 718.

At block 718, the UE 106 determines what elements in the PUCCH to multiplex the UL allocation data into in a resource block of the PUCCH 606. In this approach, the PUSCH 606 is left untouched, with the region 606 being focused in the PUCCH.

At block 720, the UE 106 places (multiplexes) the subset of UL allocation data determined from block 706 into the determined elements in the PUCCH from block 718 (identified as PUCCH 608 in FIG. 6C).

At block 722, the UE 106 echoes the UL allocation data from block 720 to the neighboring base stations 104 using the PUCCH elements (e.g., according to format 3).

At block 724, the UE 106 transmits regular data using its allocated resource block(s) in the general PUSCH region to the serving base station 104. Although described as two separate blocks (722/724), in embodiments of the present disclosure the echoed UL allocation data is transmitted using the PUCCH resource block as the secondary cluster (region 608 of FIG. 6A) at the same, or near the same, time as the regular UL data.

From either block 716 or block 724, the method 700 then proceeds to block 726. At block 726, the UE 106 again receives DCI from its serving base station 104 (which may be the same or a different base station 104 than at block 702, depending upon how mobile the UE 106 has been over the prior time period spanning one or more frames). The method 700 then proceeds back to decision block 704 and proceeds as discussed above.

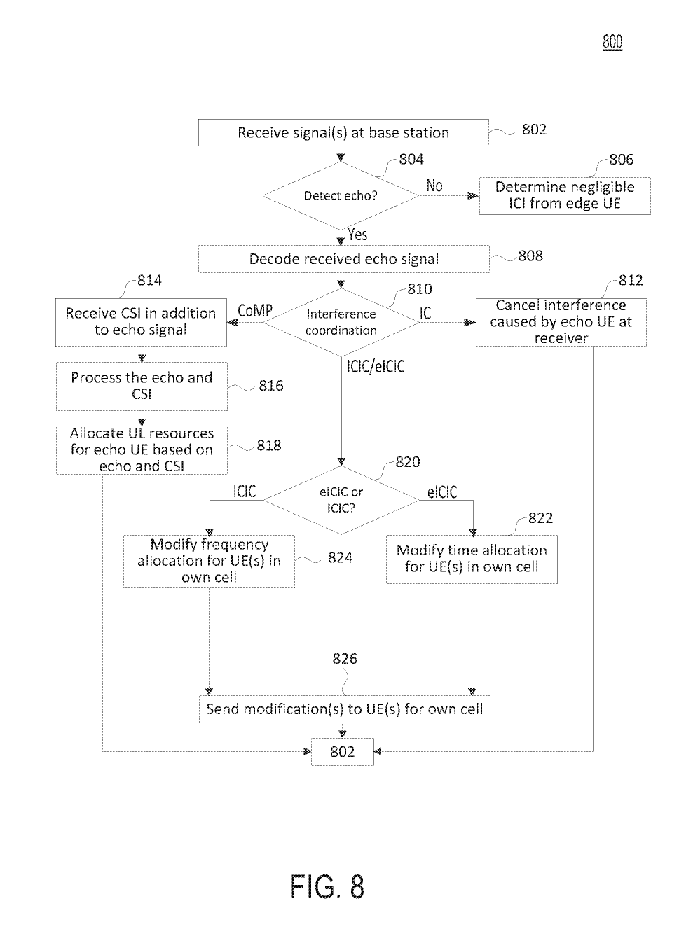

Turning now to FIG. 8, a flowchart is illustrated of an exemplary method 800 for wireless communication in accordance with various aspects of the present disclosure. In particular, the method 800 illustrates the receipt and processing of echoed UL allocation data according to embodiments of the present disclosure. Method 800 may be implemented by a base station 104 (any number of base stations 104). It is understood that additional steps can be provided before, during, and after the steps of method 800, and that some of the steps described can be replaced or eliminated from the method 800.

At block 802, the base station 104 receives one or more signals. According to embodiments of the present disclosure, in addition to receiving control and/or regular data signals from UEs 106 being served by the base station 104, the base station 104 may also receive one or more echoed UL allocation data signals from one or more UEs 106 being served in neighboring cells, e.g. because they are at an edge of the neighboring cell nearest the base station 104's cell (and/or because they are in a smaller cell within the broader coverage area of the base station 104's cell, e.g. a heterogeneous network).

At decision block 804, if the received signal is not an echoed UL allocation data signal from a UE 106 in a neighboring cell, then the method 800 proceeds to block 806, where it determines that there is negligible inter-cell interference from any UEs 106 at or near the edge of one or more neighboring cells.

If, instead, it is determined that the received signal is an echoed UL allocation data signal from a neighboring UE 106, then the method 800 proceeds to block 808.

At block 808, the base station 104 decodes the received echoed UL allocation data signal. This may be done at approximately the same time as the data is received over the air, which may be generally faster than if it were conveyed via one or more backhaul connections.

With the UL allocation from the UE 106 at a cell edge in a neighboring cell decoded, the base station 104 is ready to engage in one or more types of interference coordination. The examples used herein of interference coordination include ICIC, eICIC, CoMP, and interference cancellation, though embodiments of the present disclosure may also apply to other types as well.

At decision block 810, if the interference coordination that the base station 104 implements is interference cancellation, then the method 800 proceeds to block 812.

At block 812, the base station 104 uses the decoded UL allocation data (e.g., whatever subset of the DCI provided to the neighboring UE 106 from the UE 106's serving base station 104, whether less than all of the DCI or substantially all of it) to cancel any possible interference caused by the neighboring UE 106's PUSCH data that is intended for its serving base station 104. For example, the base station 104 may implement an interference-cancelling receiver, such as a SIC receiver (as just one example). These receives utilize the UL allocation data to identify transmissions from the assigned (neighboring) UE 106 to drop/discard/ignore those transmissions as interfering with legitimate transmissions from one or more UEs 106 being served by the base station 106. For example, in an embodiment the base station 104, in addition to simply discarding the interfering PUSCH data from the neighboring UE 106 the base station 104 may subtract the interfering signal (as identified from the echoed UL allocation data) from any other signals received at the base station 104's receiver at that same time.

Returning to decision block 810, if the interference coordination that the base station 104 implements is coordinated multi-point (CoMP), then the method 800 proceeds instead to block 814.

At block 814, the base station 104 receives one or more CSI from the neighboring UE 106 (whose echoed UL allocation data was received at block 802). Although illustrated as a separate block, the CSI may be included in the same message as the UL allocation data, in which case block 814 includes accessing the CSI from the message already decoded at block 808.

At block 816, the base station 104 processes the UL allocation data, including the CSI. The processing may include setting up the system for joint processing, coordinated scheduling, and/or coordinated beamforming for DL, and/or joint detection for UL CoMP.

At block 818, the base station 104 allocates one or more UL resources to provide CoMP to the neighboring UE 106 (whether UL, DL, or both).

Returning again to decision block 810, if the interference coordination that the base station 104 implements is some form of interference coordination, then the method 800 instead proceeds to decision block 820.

At decision block 820, if the base station 104 implements eICIC, then the method 800 proceeds to block 822.

At block 822, the base station 104 determines what UEs 106 within its own serving cell 102 to modify allocation parameters for. For example, the UEs 106 within the base station 104's serving cell that are neighboring the cell edge of the neighboring cell from which the neighboring UE 106 echoed its UL allocation data may be candidates for modification. Further, these same UEs 106 within the base station 104's serving cell may have echoed their own UL allocation data to the neighboring cell where the neighboring UE 106 is located.

Thereby, each base station 104 modifies the time resource allocations for their respective UEs 106 that they serve. In an embodiment, a priority may be established between the respective base stations 104 so to guide the decisions on which base station 104 may select which time ranges (e.g., subframes and/or frames) to allocate for UL and which to assign to be almost blank subframes. In alternative embodiments, the UEs 106 may be given data, such as a load information message (which may be based on traffic load and/or network policy), as part of its DCI. The UE 106 may include the load information in its echoed UL allocation data so that listening base stations 104 in neighboring cells may use that information to know when, and how many, to assign almost blank subframes. In another embodiment, the UL allocation data may be echoed over the air from the UEs 106 while the load information messages are conveyed via backhaul connections between the base stations 104.

Returning to decision block 820, if the base station 104 implements ICIC then the method 800 proceeds to block 824.

At block 824, the base station 104 determines what UEs 106 within its own serving cell 102 to modify allocation parameters for, such as discussed above with respect to block 822. With this determination and the echoed UL allocation data, the base station 104 then modifies frequency resource (and/or transmit power) resources (e.g., per resource block) so as to promote the avoidance of inter-cell interferences between UEs 106 at the cell edge of neighboring cells 102.

For example, in an embodiment the neighboring UE 106 may have included, as part of its echoed UL allocation data, identification of the resource blocks that it has been assigned to use at high (e.g., above a threshold) DL transmit power in the next ICIC period, the resource blocks that it has been assigned to use at high (e.g., above a threshold) UL transmit power in the next ICIC period, and—where provided by the serving base station 104 of the neighboring base station 104—identification of resource blocks that experienced high interference in the prior ICIC period. Alternatively, the identification of the resource blocks from the prior ICIC period may be provided between base stations 104 via one or more backhaul connections.

From either block 822 or 824, the method 800 proceeds to block 826. At block 826, the serving base station 104 sends the determined modifications to the determined UEs 106 in its own serving cell (e.g., that subset of UEs 106 that are both in sufficient proximity to the neighboring cell edge and that are at a determined risk of interference with the neighboring UE 106).

From either block 812 (interference cancellation), 818 (CoMP), or 826 (eICIC or ICIC), the method 800 proceeds back to block 802 to receive further signals and continue according to embodiments of the present disclosure.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C). As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method, comprising:
receiving, at a first wireless communications device, uplink configuration information in a downlink message from a second wireless communications device;
determining, by the first wireless communications device, whether the first wireless communications device is being served at a cell edge of the second wireless communications device; and
transmitting, by the first wireless communications device in response to determining it is being served at a cell edge, at least a subset of the uplink configuration information in an uplink message to a third wireless communications device.

2. The method of claim 1, wherein:
the uplink configuration information is received as part of a downlink control information (DCI) message from the second wireless communications device, and
the third wireless communications device serves a cell neighboring the cell edge served by the second wireless communications device.

3. The method of claim 1, wherein the transmitting further comprises:
placing, by the first wireless communications device, the at least subset of uplink configuration information into a subset of frequency resource blocks from a first frequency band, wherein the first frequency band is part of an uplink channel allocated for uplink data, the uplink channel further comprising a second frequency band allocated for uplink data; and
transmitting, by the first wireless communications device, the at least subset of uplink configuration information to the third wireless communications device using the subset of frequency resources from the first frequency band.

4. The method of claim 3, wherein the first frequency band has a smaller bandwidth than the second frequency band.

5. The method of claim 3, further comprising:
determining, by the first wireless communications device, the subset of frequency resource blocks based on an order of temporary identifiers associated with the second and third wireless communications devices.

6. The method of claim 3, further comprising:
transmitting, by the first wireless communications device, uplink data placed into a subset of frequency resource blocks from the second frequency band to the second wireless communications device concurrent to the transmitting the at least subset of uplink configuration information using multi-cluster transmission.

7. The method of claim 1, wherein the transmitting further comprises:
placing, by the first wireless communications device, the at least subset of uplink configuration information into a subset of frequency resource blocks from a first frequency band, wherein the first frequency band is part of an uplink control channel allocated for uplink control data, the uplink control channel further comprising a second frequency band that is part of an uplink data channel allocated for uplink data; and
transmitting, by the first wireless communications device, the at least subset of uplink configuration information to the third wireless communications device using the subset of frequency resources form the first frequency band.

8. The method of claim 7, wherein the placing further comprises:
multiplexing the at least subset of uplink configuration information for the first wireless communications device with different uplink control data from a fourth wireless communications device in a shared resource block of the first frequency band.

9. The method of claim 8, wherein the uplink control channel comprises a physical uplink control channel (PUCCH) format 3 and the uplink data channel comprises a physical uplink shared channel (PUSCH), the transmitting comprising:
transmitting the at least a subset of uplink configuration information in one or more bits of the PUCCH format 3; and
transmitting, concurrent to the transmitting the PUCCH format 3, uplink data placed into a subset of frequency resource blocks from the second frequency band to the second wireless communications device using multi-cluster transmission.

10. A method, comprising:
receiving, at a first wireless communications device of a first cell, echoed uplink configuration information from a second wireless communications device being served at a cell edge of a second cell of a third wireless communications device;
processing, upon receipt by the first wireless communications device, the echoed uplink configuration information; and
performing, upon processing by the first wireless communications device, interference coordination between the first wireless communications device and the third wireless communications device based on the echoed uplink configuration information of the second wireless communications device.

11. The method of claim 10, wherein the performing the interference coordination comprises:
modifying, by the first wireless communications device, uplink configuration information for a fourth wireless communications device being served in the first cell in response to identifying a potential inter-cell interference from the second wireless communications device being served at the cell edge of the second cell.

12. The method of claim 11, wherein the interference coordination comprises inter-cell interference coordination and the modifying further comprises:
updating, by the first wireless communications device, a frequency resource allocation for the fourth wireless communications device; and
sending, from the first wireless communications device, the updated frequency resource allocation to the fourth wireless communications device.

13. The method of claim 11, wherein the interference coordination comprises enhanced inter-cell interference coordination and the modifying further comprises:
updating, by the first wireless communications device, a time resource allocation for the fourth wireless communications device; and
sending, from the first wireless communications device, the updated time resource allocation to the fourth wireless communications device.

14. The method of claim 10, wherein the interference coordination comprises coordinated multi-point processing, the method further comprising:
receiving, by the first wireless communications device from the second wireless communications device, channel state information in addition to the echoed uplink configuration information; and
allocating, by the first wireless communications device, uplink resources for the second wireless communications device in response to the processing the echoed uplink configuration information and receiving the channel state information.

15. The method of claim 10, wherein the performing interference coordination further comprises:
cancelling, by a receiver of the first wireless communications device, interference caused by the second wireless communications device at the first wireless communications device based on one or more elements of the uplink configuration information from the second wireless communications device.

16. The method of claim 10, wherein the echoed uplink configuration information comprises at least one or more of resource allocation, modulation coding scheme, demodulation reference signal, or reduced radio network temporary identifier.

17. The method of claim 10, wherein the receiving further comprises:
receiving, by the first wireless communications device, the echoed uplink configuration information in a first frequency band, wherein the first frequency band is part of an uplink channel allocated for uplink data, the uplink channel further comprising a second frequency band allocated for uplink data.

18. The method of claim 17, wherein:
the first frequency band has a smaller bandwidth than the second frequency band, the method further comprising receiving, from a fourth wireless communications device being served in the first cell concurrent to the echoed uplink configuration information, uplink data placed into the second frequency band.

19. The method of claim 10, wherein the receiving further comprises:
receiving, by the first wireless communications device, the echoed uplink configuration information in a first frequency band, wherein the first frequency band is part of an uplink control channel allocated for uplink control data, wherein the uplink control channel is part of an uplink channel that further comprises an uplink data channel allocated for uplink data.

20. The method of claim 19, wherein the echoed uplink configuration information is multiplexed with different uplink control data from a fourth wireless communications device in a shared resource block of the first frequency band.

21. The method of claim 19, wherein:
the uplink control channel comprises a physical uplink control channel (PUCCH) format 3 and the uplink data channel comprises a physical uplink shared channel (PUSCH), and
the echoed uplink configuration information is included in one or more bits of the PUCCH format 3.

22. A first wireless communications device, comprising:
a processor configured to determine whether the first wireless communications device is being served at a cell edge of a second wireless communications device; and
a transceiver configured to:
receive uplink configuration information in a downlink message from the second wireless communications device; and
transmit, in response to the processor determining that the first wireless communications device is being served at a cell edge, at least a subset of the uplink configuration information in an uplink message to a third wireless communications device.

23. The first wireless communications device of claim 22, wherein:
the uplink configuration information is received as part of a downlink control information (DCI) message from the second wireless communications device, and
the third wireless communications device serves a cell neighboring the cell edge served by the second wireless communications device.

24. The first wireless communications device of claim 22, wherein the transceiver is further configured to:
place the at least subset of uplink configuration information into a subset of frequency resource blocks from a first frequency band, wherein the first frequency band is part of an uplink channel allocated for uplink data, the uplink channel further comprising a second frequency band allocated for uplink data; and
transmit the at least subset of uplink configuration information to the third wireless communications device using the subset of frequency resources from the first frequency band.

25. The first wireless communications device of claim 24, wherein the first frequency band has a smaller bandwidth than the second frequency band.

26. The first wireless communications device of claim 24, wherein the processor is further configured to:
determine the subset of frequency resource blocks based on an order of temporary identifiers associated with the second and third wireless communications devices.

27. The first wireless communications device of claim 24, wherein the transceiver is further configured to:
transmit uplink data placed into a subset of frequency resource blocks from the second frequency band to the second wireless communications device concurrent to the transmission of the at least subset of uplink configuration information using multi-cluster transmission.

28. The first wireless communications device of claim 22, wherein the transceiver is further configured to:
place the at least subset of uplink configuration information into a subset of frequency resource blocks from a first frequency band, wherein the first frequency band is part of an uplink control channel allocated for uplink control data, the uplink control channel further comprising a second frequency band that is part of an uplink data channel allocated for uplink data; and
transmit the at least subset of uplink configuration information to the third wireless communications device using the subset of frequency resources form the first frequency band.

29. The first wireless communications device of claim 28, wherein the transceiver is further configured, as part of the placement, to:
multiplex the at least subset of uplink configuration information for the first wireless communications device with different uplink control data from a fourth wireless communications device in a shared resource block of the first frequency band.

30. The first wireless communications device of claim 29, wherein the uplink control channel comprises a physical uplink control channel (PUCCH) format 3 and the uplink data channel comprises a physical uplink shared channel (PUSCH), the transceiver further configured to:
transmit the at least a subset of uplink configuration information in one or more bits of the PUCCH format 3; and
transmit, concurrent to the transmission of the PUCCH format 3, uplink data placed into a subset of frequency resource blocks from the second frequency band to the second wireless communications device using multi-cluster transmission.

31. A first wireless communications device, comprising:
a transceiver configured to receive, at the first wireless communications device of a first cell, echoed uplink configuration information from a second wireless communications device being served at a cell edge of a second cell of a third wireless communications device; and
a processor configured to:
process, upon receipt by the first wireless communications device, the echoed uplink configuration information; and
perform, upon processing by the first wireless communications device, interference coordination between the first wireless communications device and the third wireless communications device based on the echoed uplink configuration information of the second wireless communications device.

32. The first wireless communications device of claim 31, wherein the processor is further configured, as part of the interference coordination, to:
modify uplink configuration information for a fourth wireless communications device being served in the first cell in response to identifying a potential inter-cell interference from the second wireless communications device being served at the cell edge of the second cell.

33. The first wireless communications device of claim 32, wherein the interference coordination comprises inter-cell interference coordination, and the processor is further configured, as part of the modifying, to:
update a frequency resource allocation for the fourth wireless communications device; and
send the updated frequency resource allocation to the fourth wireless communications device.

34. The first wireless communications device of claim 32, wherein:
the interference coordination comprises enhanced inter-cell interference coordination,
the processor is further configured, as part of the modifying, to update a time resource allocation for the fourth wireless communications device, and
the transceiver is further configured to send the updated time resource allocation to the fourth wireless communications device.

35. The first wireless communications device of claim 31, wherein:
the interference coordination comprises coordinated multi-point processing,
the transceiver is further configured to receive from the second wireless communications device, channel state information in addition to the echoed uplink configuration information, and
the processor is further configured to allocate uplink resources for the second wireless communications device in response to the processing of the echoed uplink configuration information and receipt of the channel state information.

36. The first wireless communications device of claim 31, wherein the transceiver is further configured, as part of the interference coordination, to:
cancel interference caused by the second wireless communications device at the first wireless communications device based on one or more elements of the uplink configuration information from the second wireless communications device.

37. The first wireless communications device of claim 36, wherein the transceiver comprises a successive interference cancellation receiver.

38. The first wireless communications device of claim 31, wherein the echoed uplink configuration information comprises at least one or more of resource allocation, modulation coding scheme, demodulation reference signal, or reduced radio network temporary identifier.

39. The first wireless communications device of claim 31, wherein the transceiver is further configured to:
receive the echoed uplink configuration information in a first frequency band, wherein the first frequency band is part of an uplink channel allocated for uplink data, the uplink channel further comprising a second frequency band allocated for uplink data.

40. The first wireless communications device of claim 39, wherein:
the first frequency band has a smaller bandwidth than the second frequency band, and
the transceiver is further configured to receive, from a fourth wireless communications device being served in the first cell concurrent to the echoed uplink configuration information, uplink data placed into the second frequency band.

41. The first wireless communications device of claim 31, wherein the transceiver is further configured to:
receive the echoed uplink configuration information in a first frequency band, wherein the first frequency band is part of an uplink control channel allocated for uplink control data, and the uplink control channel is part of an uplink channel that further comprises an uplink data channel allocated for uplink data.

42. The first wireless communications device of claim 41, wherein the echoed uplink configuration information is multiplexed with different uplink control data from a fourth wireless communications device in a shared resource block of the first frequency band.

43. The first wireless communications device of claim 41, wherein:
the uplink control channel comprises a physical uplink control channel (PUCCH) format 3 and the uplink data channel comprises a physical uplink shared channel (PUSCH), and
the echoed uplink configuration information is included in one or more bits of the PUCCH format 3.

44. A computer-readable medium having program code recorded thereon, the program code comprising:
code for causing a first wireless communications device to receive uplink configuration information in a downlink message from a second wireless communications device;
code for causing the first wireless communications device to determine whether the first wireless communications device is being served at a cell edge of the second wireless communications device; and
code for causing the first wireless communications device to transmit, in response to determining the first wireless communications device is being served at a cell edge, at least a subset of the uplink configuration information in an uplink message to a third wireless communications device.

45. The computer-readable medium of claim 44, wherein:
the uplink configuration information is received as part of a downlink control information (DCI) message from the second wireless communications device, and
the third wireless communications device serves a cell neighboring the cell edge served by the second wireless communications device.

46. The computer-readable medium of claim 44, further comprising:
code for causing the first wireless communications device to place the at least subset of uplink configuration information into a subset of frequency resource blocks from a first frequency band, wherein the first frequency band is part of an uplink channel allocated for uplink data, the uplink channel further comprising a second frequency band allocated for uplink data; and
code for causing the first wireless communications device to transmit the at least subset of uplink configuration information to the third wireless communications device using the subset of frequency resources from the first frequency band.

47. The computer-readable medium of claim 46, wherein the first frequency band has a smaller bandwidth than the second frequency band.

48. The computer-readable medium of claim 46, further comprising:
code for causing the first wireless communications device to the subset of frequency resource blocks based on an order of temporary identifiers associated with the second and third wireless communications devices.

49. The computer-readable medium of claim 46, further comprising:
code for causing the first wireless communications device to transmit uplink data placed into a subset of frequency resource blocks from the second frequency band to the second wireless communications device concurrent to the transmitting the at least subset of uplink configuration information using multi-cluster transmission.

50. The computer-readable medium of claim 44, further comprising:
code for causing the first wireless communications device to place the at least subset of uplink configuration information into a subset of frequency resource blocks from a first frequency band, wherein the first frequency band is part of an uplink control channel allocated for uplink control data, the uplink control channel further comprising a second frequency band that is part of an uplink data channel allocated for uplink data; and
code for causing the first wireless communications device to transmit the at least subset of uplink configuration information to the third wireless communications device using the subset of frequency resources form the first frequency band.

51. The computer-readable medium of claim 50, further comprising:
code for causing the first wireless communications device to multiplex the at least subset of uplink configuration information for the first wireless communications device with different uplink control data from a fourth wireless communications device in a shared resource block of the first frequency band.

52. The computer-readable medium of claim 51, wherein the uplink control channel comprises a physical uplink control channel (PUCCH) format 3 and the uplink data channel comprises a physical uplink shared channel (PUSCH), further comprising:
code for causing the first wireless communications device to transmit the at least a subset of uplink configuration information in one or more bits of the PUCCH format 3; and
code for causing the first wireless communications device to transmit, concurrent to the transmitting the PUCCH format 3, uplink data placed into a subset of frequency resource blocks from the second frequency band to the second wireless communications device using multi-cluster transmission.

53. A computer-readable medium having program code recorded thereon, the program code comprising:
code for causing a first wireless communications device of a first cell to receive echoed uplink configuration information from a second wireless communications device being served at a cell edge of a second cell of a third wireless communications device;
code for causing the first wireless communications device to process, upon receipt by the first wireless communications device, the echoed uplink configuration information; and
code for causing the first wireless communications device to perform, upon processing by the first wireless communications device, interference coordination between the first wireless communications device and the third wireless communications device based on the echoed uplink configuration information of the second wireless communications device.

54. The computer-readable medium of claim 53, further comprising:
code for causing the first wireless communications device to modify uplink configuration information for a fourth wireless communications device being served in the first cell in response to identifying a potential inter-cell interference from the second wireless communications device being served at the cell edge of the second cell.

55. The computer-readable medium of claim 54, wherein the interference coordination comprises inter-cell interference coordination, further comprising:
code for causing the first wireless communications device to update a frequency resource allocation for the fourth wireless communications device; and
code for causing the first wireless communications device to send the updated frequency resource allocation to the fourth wireless communications device.

56. The computer-readable medium of claim 54, wherein the interference coordination comprises enhanced inter-cell interference coordination, further comprising:
code for causing the first wireless communications device to update a time resource allocation for the fourth wireless communications device; and
code for causing the first wireless communications device to send the updated time resource allocation to the fourth wireless communications device.

57. The computer-readable medium of claim 53, wherein the interference coordination comprises coordinated multi-point processing, further comprising:
code for causing the first wireless communications device to receive, from the second wireless communications device, channel state information in addition to the echoed uplink configuration information; and
code for causing the first wireless communications device to allocate uplink resources for the second wireless communications device in response to the processing the echoed uplink configuration information and receiving the channel state information.

58. The computer-readable medium of claim 53, further comprising:
code for causing the first wireless communications device to cancel, by a receiver of the first wireless communications device, interference caused by the second wireless communications device at the first wireless communications device based on one or more elements of the uplink configuration information from the second wireless communications device.

59. The computer-readable medium of claim 53, wherein the echoed uplink configuration information comprises at least one or more of resource allocation, modulation coding scheme, demodulation reference signal, or reduced radio network temporary identifier.

60. The computer-readable medium of claim 53, further comprising:
code for causing the first wireless communications device to receive the echoed uplink configuration information in a first frequency band, wherein the first frequency band is part of an uplink channel allocated for uplink data, the uplink channel further comprising a second frequency band allocated for uplink data.

61. The computer-readable medium of claim 60, wherein:
the first frequency band has a smaller bandwidth than the second frequency band, further comprising receiving, from a fourth wireless communications device being served in the first cell concurrent to the echoed uplink configuration information, uplink data placed into the second frequency band.

62. The computer-readable medium of claim 53, further comprising:
code for causing the first wireless communications device to receive the echoed uplink configuration information in a first frequency band, wherein the first frequency band is part of an uplink control channel allocated for uplink control data, wherein the uplink control channel is part of an uplink channel that further comprises an uplink data channel allocated for uplink data.

63. The computer-readable medium of claim 62, wherein the echoed uplink configuration information is multiplexed with different uplink control data from a fourth wireless communications device in a shared resource block of the first frequency band.

64. The computer-readable medium of claim 62, wherein:
the uplink control channel comprises a physical uplink control channel (PUCCH) format 3 and the uplink data channel comprises a physical uplink shared channel (PUSCH), and
the echoed uplink configuration information is included in one or more bits of the PUCCH format 3.
